(19) United States
(12) Patent Application Publication
(10) Pub. No.: US 2010/0120953 A1
(43) Pub. Date: May 13, 2010

(54) Highly Filled, Propylene-Ethylene Copolymer Compositions

(76) Inventors: Maarten W. Aarts, Hutten (CH); Miguel A. Prieto, Richterswil (CH)

Correspondence Address: WHYTE HIRSCHBOECK DUDEK S.C./DOW;Intellectual Property Department, 555 East Wells Street, Suite 1900, Milwaukee, WI, 53202, US

(21) Appl. No.: 12/611,621

(22) Filed: Nov. 3, 2009

Related U.S. Application Data
(60) Provisional application No. 61/113,777, filed on Nov. 12, 2008.

(51) Int. Cl. C08K 5/56

(52) U.S. Cl. 524/176

(57) ABSTRACT

Compositions comprising, based on the weight of the composition:
A. Less than 50 wt % of a propylene-ethylene copolymer comprising between 8 and 20 wt % of units derived from ethylene, based on the total weight of the copolymer;
B. At least 50 wt % of a filler; and
C. Between greater than zero and 1 wt % of a titanate compound.
   The propylene-ethylene copolymer typically has a low crystallinity of between greater than zero and 35%, and the filler is typically an inorganic material such as aluminum trihydrate and/or calcium carbonate. Mono-alkoxy-titanate is representative of the titanate compounds that can be used in this invention.

### CROSS REFERENCE TO RELATED APPLICATION

The present application claims priority to U.S. patent application Ser. No. 61/113,777, filed on Nov. 12, 2008, the entire content of which is incorporated by reference herein.

### FIELD OF THE INVENTION

This invention relates to filled, polymer-based compositions. In one aspect, the invention relates to filled, polypropylene-based compositions while in another aspect, the invention relates to highly filled, low crystalline, propylene-ethylene (P-E) copolymer compositions. In still another aspect, the invention relates to highly filled, low crystalline, P-E copolymer compositions comprising a titanate compound while in yet another aspect, the invention relates to wire and cable constructions comprising such a composition.

### BACKGROUND OF THE INVENTION

Polymer-based compositions filled with high levels, e.g., in excess of 50 weight percent (wt %) based on the combined weight of the polymer and filler, of one or more inorganic fillers are commonly used in the construction of cable. These compositions impart a smooth, circular surface about the twisted wires of the cable, allow the outer jacket of the cable to be stripped or removed with relative ease, and contribute significantly to the burn characteristics of the cable. Moreover, these compositions are typically processable at a temperature below 110° C. to limit the transfer of heat to the underlying cable structure. For economic and other reasons, e.g., flame retardancy, generally the more filler in the composition, the better.

Current cables are constructed from any one of a number of different polymer compositions. One such composition is based on polypropylene while other such compositions are based on polyvinylchloride (PVC), or ethylene-propylene-diene monomer (EPDM), or ethylene/α-olefin copolymer, e.g., ethylene-octene copolymer. While each of these polymers has its own advantages, each also has its own disadvantages. For example, at very high filler levels, e.g., 90 wt % or more, polypropylene does not exhibit comparable tensile strength and elongation properties of EPDM or an ethylene/octene copolymer. PVC polymers do not readily accept high loadings of filler, they must be stabilized against de-hydrochlorination, and they cannot be used in halogen-free cable constructions. Filled EPDM and ethylene/octene copolymers do not achieve the same level of mechanical properties at the same melt viscosity as PVC.

The fillers are typically inorganic, and include such materials as calcium carbonate, talc, barium sulfate and/or one or more flame retardants. These fillers, however, often have a deleterious effect on one or more of the mechanical properties, e.g., tensile, elongation, elasticity, etc., of the cable. These deleterious effects can be mitigated to a limited extent through the use of a coupling agent, e.g., a titanate or zirconate compound. These coupling agents can also improve the rheological properties of the composition under melt conditions.

Of continuing interest to the cable construction industry are cables having both very high loadings of filler and excellent mechanical properties.

### SUMMARY OF THE INVENTION

In one embodiment, the invention is a composition comprising, based on the weight of the composition:
A. From greater than zero to less than 50 wt % of a propylene-ethylene (P-E) copolymer comprising between 8 and 20 wt % of units derived from ethylene, based on the total weight of the copolymer;
B. At least 50 wt % of a filler; and
C. Between greater than zero and 1 wt % of a titanate compound.
   The propylene-ethylene copolymer typically has a low crystallinity of between greater than zero and 35%, and the filler is typically an inorganic material such as aluminum trihydrate and/or calcium carbonate. Mono-alkoxy-titanate is representative of the titanate compounds that can be used in this invention.

At filler levels of 90 wt % or more, the tensile strength and elongation properties of the compositions of this invention are greater than that of compositions comprising similar fillers at similar fill levels and EPDM or ethylene-octene copolymers. Moreover, these compositions exhibit lower mixing torque which results in higher output and/or reduced energy consumption.

In another embodiment, the invention is an article comprising the composition described above. Representative articles include cable, roofing membranes, sound deadening sheets, shoe soles, pipes and the like.

### DESCRIPTION OF THE PREFERRED EMBODIMENT

All references to the Periodic Table of the Elements refer to the Periodic Table of the Elements published and copyrighted by CRC Press, Inc., 2003. Also, any references to a Group or Groups shall be to the Group or Groups reflected in this Periodic Table of the Elements using the IUPAC system for numbering groups. Unless stated to the contrary, implicit from the context, or customary in the art, all parts and percents are based on weight and all test methods are current as of the filing date of this disclosure. For purposes of United States patent practice, the contents of any referenced patent, patent application or publication are incorporated by reference in their entirety (or its equivalent US version is so incorporated by reference) especially with respect to the disclosure of synthetic techniques, definitions (to the extent not inconsistent with any definitions specifically provided in this disclosure), and general knowledge in the art.

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a process parameter, such as, for example, temperature, is from 100 to 1,000, it is intended that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, the amount of filler relative to the composition, the amount of coupling agent relative to composition, the ethylene content of the P-E copolymers, and various temperature and other process ranges.

“Cable”, “power cable”, “transmission line” and like terms mean at least one wire or optical fiber within a protective jacket or sheath. Typically, a cable is two or more wires or optical fibers bound together, typically in a common protective jacket or sheath. The individual wires or fibers inside the jacket may be bare, covered or insulated. Combination cables may contain both electrical wires and optical fibers. The cable, etc. can be designed for low, medium and high voltage applications. Typical cable designs are illustrated in U.S. Pat. Nos. 5,246,783, 6,496,629 and 6,714,707.

The term “comprising” and its derivatives are not intended to exclude the presence of any additional component, step or procedure, whether or not the same is specifically disclosed. In order to avoid any doubt, all compositions claimed through use of the term “comprising” may include any additional additive, adjuvant, or compound whether polymeric or otherwise, unless stated to the contrary. In contrast, the term, “consisting essentially of excludes from the scope of any succeeding recitation any other component, step or procedure, excepting those that are not essential to operability. The term “consisting of excludes any component, step or procedure not specifically delineated or listed. The term “or”, unless stated otherwise, refers to the listed members individually as well as in any combination.

As used with respect to a chemical compound, unless specifically indicated otherwise, the singular includes all isomeric forms and vice versa (for example, “hexane”, includes all isomers of hexane individually or collectively). The terms “compound” and “complex” are used interchangeably to refer to organic-, inorganic- and organometal compounds. The term, “atom” refers to the smallest constituent of an element regardless of ionic state, that is, whether or not the same bears a charge or partial charge or is bonded to another atom. The term “amorphous” refers to a polymer lacking a crystalline melting point as determined by differential scanning calorimetry (DSC) or equivalent technique.

“Polymer” means a polymeric compound prepared by polymerizing monomers, whether of the same or a different type. The generic term polymer thus embraces the term homopolymer, usually employed to refer to polymers prepared from only one type of monomer, and the term interpolymer as defined below. It also embraces all forms of interpolymers, e.g., random, block, etc.

“Interpolymer” means a polymer prepared by the polymerization of at least two different types of monomers. This generic term includes copolymers, usually employed to refer to polymers prepared from two different types of monomers, and polymers prepared from more than two different types of monomers, e.g., terpolymers, tetrapolymers, etc.

“Polyolefin”, “PO” and like terms mean a polymer derived from simple olefins. Representative polyolefins include polyethylene, polypropylene, polybutene, polyisoprene and their various interpolymers, e.g., ethylene-propylene copolymer, P-E copolymer and the like.

“Blend”, “polymer blend” and like terms mean a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art.

The P-E copolymers of this invention comprise at least 8, preferably at least 10 and more preferably at least 12, wt % of units derived from ethylene based on the weight of the copolymer. As a general maximum, the P-E copolymers of this invention comprise less than 20, preferably less than 18 and more preferably less than 16, wt % of units derived from ethylene based on the weight of the copolymer.

The P-E copolymers used in the practice of this invention typically comprise less than 50, preferably less than 40 and more preferably less than 30, wt % of the composition. Typically, the minimum amount of P-E copolymer in the composition is 5, more typically 7, wt % of the composition.

The P-E copolymers of this invention can be produced using conventional propylene polymerization technology, e.g., Ziegler-Natta, metallocene or constrained geometry catalysis. Preferably, the P-E copolymer is made using a mono- or bis-cyclopentadienyl, indenyl, or fluorenyl transition metal (preferably Group 4) catalysts or constrained geometry catalysts (CGC) in combination with an activator, in a solution, slurry, or gas phase polymerization process. The catalyst is preferably mono-cyclopentadienyl, mono-indenyl or mono-fluorenyl CGC. The solution process is preferred. U.S. Pat. No. 5,064,802, WO93/19104 and WO95/00526 disclose constrained geometry metal complexes and methods for their preparation. Variously substituted indenyl containing metal complexes are taught in WO95/14024 and WO98/49212.

In general, polymerization can be accomplished at conditions well known in the art for Ziegler-Natta or Kaminsky-Sinn type polymerization reactions, that is, at temperatures from 0-250° C., preferably 30-200° C., and pressures from atmospheric to 10,000 atmospheres (1013 megaPascal (MPa)). Suspension, solution, slurry, gas phase, solid state powder polymerization or other process conditions may be employed if desired. The catalyst can be supported or unsupported, and the composition of the support can vary widely. Silica, alumina or a polymer (especially poly(tetrafluoroethylene) or a polyolefin) are representative supports, and desirably a support is employed when the catalyst is used in a gas phase polymerization process. The support is preferably employed in an amount sufficient to provide a weight ratio of catalyst (based on metal) to support within a range of from 1:100,000 to 1:10, more preferably from 1:50,000 to 1:20, and most preferably from 1:10,000 to 1:30. In most polymerization reactions, the molar ratio of catalyst to polymerizable compounds employed is from 10⁻¹²:1 to 10⁻¹:1, more preferably from 10⁻⁹:1 to 10⁻⁵:1.

Inert liquids serve as suitable solvents for polymerization. Examples include straight and branched-chain hydrocarbons such as isobutane, butane, pentane, hexane, heptane, octane, and mixtures thereof; cyclic and alicyclic hydrocarbons such as cyclohexane, cycloheptane, methylcyclohexane, methylcycloheptane, and mixtures thereof; perfluorinated hydrocarbons such as perfluorinated C₄₋₁₀ alkanes; and aromatic and alkyl-substituted aromatic compounds such as benzene, toluene, xylene, and ethylbenzene.

The P-E copolymers of this invention can be used alone or in combination with one or more other polymers. If used in combination with one or more other polymers, typically the one or more other polymers is a polyolefin, preferably another P-E copolymer that differs from the first P-E copolymer by ethylene content, catalytic method of preparation, etc. If the P-E copolymer is used in combination with one or more other polymers, including P-E copolymers with an ethylene content less than 8 wt % or greater than 20 wt %, then the P-E copolymer used in the practice of this invention typically comprises at least 50 wt % of the combination. The P-E copolymer and one or more other polymers can be mixed or blended by any in-reactor or post-reactor process. The in-reactor blending processes are preferred to the post-reactor blending processes, particularly for making blends of two or more P-E copolymers, and the processes using multiple reactors connected in series are the preferred in-reactor blending processes. These reactors can be charged with the same catalyst but operated at different conditions, e.g., different reactant concentrations, temperatures, pressures, etc, or operated at the same conditions but charged with different catalysts.

The polydispersity (molecular weight distribution or MWD or Mw/Mn in which Mw is weight average molecular weight and Mn is number average molecular weight) of the P-E copolymer generally ranges from at least 2.0, preferably at least 2.3, and especially at least 2.4 to 4.0, preferably 3.0, and especially 2.8. The polydispersity index is typically measured by gel permeation chromatography (GPC) on a Waters 150 C high temperature chromatographic unit equipped with three linear mixed bed columns (Polymer Laboratories (10 micron particle size)) operating at a system temperature of 140 C. The solvent is 1,2,4-trichlorobenzene from which 0.5% by weight solutions of the samples are prepared for injection. The flow rate is 1.0 milliliter/minute (ml/min), and the injection size is 100 microliters (μl).

The molecular weight determination is deduced by using narrow molecular weight distribution polystyrene standards (from Polymer Laboratories) in conjunction with their elusion volumes. The equivalent polyethylene molecular weights are determined by using appropriate Mark-Houwink coefficients for polyethylene and polystyrene (as described by Williams and Ward in Journal of Polymer Science, Polymer Letters, Vol. 6, (621) 1968) to derive the equation:

M_{polyethylene}=(a)(M_{polystyrene})^{b}

In this equation, a=0.4316 and b=1.0. Weight average molecular weight, Mw, is calculated in the usual manner according to the formula:

Mw=Σ(wᵢ)(Mᵢ)

where wᵢ and Mᵢ are the weight fraction and molecular weight respectively of the i^{th} fraction eluting from the GPC column. Generally, the Mw of the P-E copolymer or copolymer blend is from 150,000, preferably 170,000, more preferably 180,000, and especially 187,000, to 350,000, preferably 300,000, more preferably 280,000, and especially 275,000.

The density of the P-E copolymer is measured according to ASTM D-792, and this density ranges from a minimum of 0.850 grams/cubic centimeter (g/cm³), preferably 0.853 g/cm³, and especially 0.855 g/cm³, to a maximum of 0.89 g/cm³, preferably 0.88 g/cm³, and especially 0.875 g/cm³.

The crystallinity of the P-E copolymers of this invention is typically less than 35, preferably less than 30 and more preferably less than 20, percent, preferably in combination with a melting point of less than 60°, preferably less than 50°, C, respectively. P-E copolymers with a crystallinity of greater than zero (e.g., not completely amorphous) to 15 percent are even more preferred. The percent crystallinity is determined by dividing the heat of fusion as determined by differential scanning calorimetry (DSC) of an P-E copolymer sample by the total heat of fusion for that polymer sample.

The fillers and/or flame retardants used in the practice of this invention comprise at least 50, preferably at least 60 and more preferably at least 70, wt % of the composition. At filler levels of 90 wt % or more, the tensile strength and elongation properties of the compositions of this invention can be greater than that of compositions comprising similar fillers at similar fill levels and EPDM or ethylene-octene copolymers. The only limit on the maximum amount of fillers and/or flame retardants in the composition is the ability of the P-E copolymer matrix to hold the filler and/or flame retardant, but typically a general maximum comprises less than 95, more typically less than 93, wt % of the composition.

Representative fillers and flame retardants include talc, calcium carbonate, organo-clay, glass fibers, marble dust, cement dust, feldspar, silica or glass, fumed silica, silicates, alumina, various phosphorus compounds, ammonium bromide, antimony trioxide, zinc oxide, zinc borate, barium sulfate, silicones, aluminum silicate, calcium silicate, titanium oxides, glass microspheres, chalk, mica, clays, wollastonite, ammonium octamolybdate, intumescent compounds, expandable graphite, and mixtures of two or more of these materials. The fillers may carry or contain various surface coatings or treatments, such as silanes, fatty acids, and the like. Halogenated organic compounds including halogenated hydrocarbons such as chlorinated paraffin, halogenated aromatic compounds such as pentabromotoluene, decabromodiphenyl oxide, decabromodiphenyl ethane, ethylene-bis(tetrabromophthalimide), dechlorane plus and other halogen-containing flame retardants. One skilled in the art will recognize and select the appropriate halogen agent consistent with the desired performance of the composition. The composition can further comprise various other additives. Moisture cure catalysts, such as dibutyltin dilaurate or distannoxanes, are normally added for moisture-curable resins. Peroxides and free-radical initiators can be added for crosslinking the resin. Additionally, pigments and dyes may be added as desired.

The composition can contain other additives such as, for example, antioxidants (e.g., hindered phenols such as, for example, IRGANOX™ 1010 a registered trademark of Ciba Specialty Chemicals), phosphites (e.g., IRGAFOS™ 168 a registered trademark of Ciba Specialty Chemicals), UV stabilizers, cling additives, light stabilizers (such as hindered amines), plasticizers (such as dioctylphthalate or epoxidized soy bean oil), thermal stabilizers, mold release agents, tackifiers (such as hydrocarbon tackifiers), waxes (such as polyethylene waxes), processing aids (such as oils, organic acids such as stearic acid, metal salts of organic acids), crosslinking agents (such as peroxides or silanes), colorants or pigments to the extent that they do not interfere with desired loadings and/or physical or mechanical properties of the compositions of the present invention, and other flame retardant additives. The above additives are employed in functionally equivalent amounts known to those skilled in the art, generally in amounts of up to 30 percent by weight, based upon the total weight of the composition.

The coupling agents used in the practice of this invention comprise at least greater than zero, preferably at least 0.05 and more preferably at least 0.1, wt % of the composition. The only limit on the maximum amount of coupling agents in the composition is that imposed by economics and practicality, but typically a general maximum comprises less than 1, preferably less than 0.5 and more preferably less than 0.3, wt % of the composition.

Representative titanate coupling agents include:
mono-alkoxy-titanate;
titanium(IV) 2-propanolato, tris(isooctadecanoato-O);
titanium(IV) bis(2-methyl-2propenoato-O), isooctadecanoato-O, 2-propanolato;
titanium(IV) 2-propanolato, tris(dodecyl)benzenesulfonato-O;
titanium(IV), tri(2-methyl)-2-propenoato-O, methoxydiglycolylato;
titanium(IV) 2-propanolato, tris(dioctyl)pyrophosphato-O);
titanium(IV) tetrakis(2-propanolato), adduct with 2 moles (dioctyl)hydrogen phosphite;
titanium(IV) tetrakis(octanolato) adduct with 2 moles (ditridecyl)hydrogen phosphite;
titanium(IV) tetrakis[bis(2-propenolato methyl)-1-butanolato] adduct with 2 moles (ditridecyl)hydrogen phosphite;
titanium(IV) oxoethylene-diolato, bis(dioctyl)phosphato-O;
titanium(IV) bis(dioctyl)pyrophosphate-O, oxoethylenediolato (adduct), (dioctyl) (hydrogen)phosphite-O;
titanium(IV) ethylenediolato, bis(dioctyl)pyrophosphato-O;
titanium(IV) 2,2-bis(2-propenolatomethyl)butanolato, tris(neodecanoato-O);
titanium(IV) 2,2bis(2-propenolatomethyl)butanolato, tris(dodecyl)benzene-sulfonato-O;
titanium(IV) 2,2-bis(2-propenolatomethyl)butanolato, tris(dioctyl)phosphato-O;
titanium(IV) 2,2-bis(2-propenolatomethyl)butanolato, tris(dioctyl)pyrophospato-O;
titanium(IV) 2,2-bis(2-propenolatomethyl)butanolato, tris(dioctyl)pyrophosphate-O/ethoxylated nonyl phenol (1:1);
titanium(IV) bis(2-propenolatomethyl)-1-butanolato, bis(dioctyl)pyrophosphate-O, adduct with 3 moles N,N-dimethylaminoalkyl propenoamide;
titanium(IV) 2,2-bis(2-propenolatomethyl), tris(2-ethylenediamimo)ethylato; and
titanium(IV) 2,2-bis(2-propenolatomethyl)butanolato, tris(3-amino)phenylato.

The compositions of this invention are used in cable construction in the same manner as known compositions. In addition to cable insulation and jackets, the compositions of this invention can be used in the manufacture of roofing membranes, sound deadening sheets and articles, shoe soles and other extruded profiles, sheets and pipes. Still other articles of manufacture include various (i) automobile parts such as interior cover materials of, for example, instrument panels, console boxes, arm rests, head rests, door trims, rear panels, pillar trims, sun visors, trunk room trims, trunk lid trims, air bag covers, seat buckles, head liners, gloves boxes and steering wheel covers; interior molded articles of, for example, kicking plates and change lever boots; exterior parts of for example, spoilers, side moles, number plate housings, mirror housings, air dam skirt and mud guards; and other molded articles of automobile parts; (ii) sporting goods such as decorative parts of sport shoes, grips of rackets, sport tools and goods of various ball games, covering materials of saddles and handlebar grips of bicycles, motor-cycles and tricycles, etc.; (iii) housing and building materials such as covering materials of furniture, desks, chairs, etc.; covering materials of gates, doors, fences, etc.; wall decorative materials; covering materials of curtain walls; indoor flooring materials of kitchens, wash rooms, toilets, etc; outdoor flooring materials such as verandas, terraces, balconies, carports, etc.; carpets such as front door or entrance mats, table cloths, coasters, ash tray doilies; (iv) industrial parts such as grips and hoses for electric tools, etc., and the covering materials thereof; packing materials; and (v) assorted other items such as covering materials of bags, briefcases, cases, files, pocket books, albums, stationary, camera bodies, dolls and the other toys, and molded articles such as watch bands, outer frames of picture or photograph and their covering materials.

The following examples illustrate various embodiments of this invention. All parts and percentages are by weight unless otherwise indicated.

### Specific Embodiments

### Sample Preparation:

Mixtures are prepared containing 15 wt % of a propylene-ethylene-propylene (P-E) copolymer or an ethylene-octene copolymer, 35 wt % of Martinal OL 104 CL (an aluminum trihydrate), 50 wt % Omyacarb 40GU (calcium carbonate), and a minor proportion of Capow KR TTS/H (mono-alkoxy-titanate). The P-E copolymers comprise 15 wt % ethylene based on the weight of the polymer. P-E copolymer 1 has a density of 0.858, a crystallinity of 14%, an MI of 2.0, and an MWD of 275,000. P-E copolymer 2 has a density of 0.858, a crystallinity of 14%, an MI of 8.0, and an MWD of 187,000. The ethylene-octene copolymer is AFFINITY EG8200 available from The Dow Chemical Company (0.872 g/cc density, 20% crystallinity and 5 g/10 min MI).

The mixtures are made in a Thermo-Hawke Inc., mixing chamber with a volume of 85 cubic centimeters using cam rotors. All materials are pre-mixed, using about one-third of the total filler amount. This is added to the chamber and blended for 5 minutes at 150 C and 80 revolutions per minute. Subsequently the remaining powder is added, and the resulting mix blended for another 10 minutes at the same temperature and rotor speed. The rotor torque in Newtons per meter (N/m) is reported in Table 1.

TABLE 1
Rotor Torque (N/m) of Filled, Polymer-Based Compositions

| | Addition Level | | | | |
|---|---|---|---|---|---|
| | of Titanate (wt %) | | | | |
| | 0 | 0.4 | 0.6 | 0.8 | 1 |
| P-E Copolymer 1 | 40 | 38 | 36 | 34 | 30 |
| (N/m) | | | | | |
| P-E Copolymer 2 | 35 | 32 | 31 | 30 | 28 |
| (N/m) | | | | | |
| Ethylene-Octene | 60 | 55 | 50 | 45 | 40 |
| Copolymer | | | | | |
| (N/m) | | | | | |

The lower torque indicates a lower energy uptake during the production of highly filled compounds with P-E copolymers. Also shown is that the addition of mono-alkyl-titanate to highly filled compositions of P-E copolymers further reduces the energy uptake.

Compression molded plates are made with a thickness of 2 mm using a Buerkle Press at 140 C for 2 minutes at 10 bar followed by 4 minutes at 200 bar. Tensile tests are conducted according to ISO 527. The ultimate elongation in percent is summarized in Table 2.

TABLE 2
Ultimate Elongation (%) of Filled, Polymer-Based Compositions

| | Addition Level | | | | |
|---|---|---|---|---|---|
| | of Titanate (wt %) | | | | |
| | 0 | 0.4 | 0.6 | 0.8 | 1 |
| P-E Copolymer-1 | 12 | 22 | 27 | 33 | 79 |
| (%) | | | | | |
| P-E Copolymer-2 | 14 | 18 | 18 | 20 | 24 |
| (%) | | | | | |
| Ethylene-Octene | 5 | 6 | 5 | 7 | 9 |
| Copolymer | | | | | |
| (%) | | | | | |

The better ultimate elongation demonstrates the much improved property retention at high filler loadings of the P-E copolymers, both initially and after the addition of mono-alkoxy-titanate.

Although the invention has been described in considerable detail by the preceding specification, this detail is for the purpose of illustration and is not to be construed as a limitation upon the following appended claims.

What is claimed is:

1. A composition comprising, based on the weight of the composition:
A. From greater than zero to less than 50 wt % of a propylene-ethylene (P-E) copolymer comprising between 8 and 20 wt % of units derived from ethylene, based on the total weight of the copolymer;
B. At least 50 wt % of a filler; and
C. Between greater than zero and 1 wt % of a titanate compound.

2. The composition of claim 1 in which the P-E copolymer comprises between 10 and 18 wt % of units derived from ethylene.

3. The composition of claim 1 comprising at least 70 wt % of a filler.

4. The composition of claim 1 in which the filler is at least one of talc, calcium carbonate, organo-clay, glass fibers, marble dust, cement dust, feldspar, silica or glass, fumed silica, silicates, alumina, various phosphorus compounds, ammonium bromide, antimony trioxide, zinc oxide, zinc borate, barium sulfate, silicones, aluminum silicate, calcium silicate, titanium oxides, glass microspheres, chalk, mica, clays, wollastonite, ammonium octamolybdate, intumescent compounds and expandable graphite.

5. The composition of claim 1 comprising between 0.05 and 0.5 wt % of the titanate compound.

6. The composition of claim 1 in which the titanate compound is mono-alkoxy titanate.

7. The composition of claim 1 in which the P-E copolymer comprises a blend of a first P-E copolymer and a second polymer.

8. The composition of claim 7 in which the first P-E copolymer comprises at least 50 wt % of the blend.

9. The composition of claim 8 in which the second polymer is a P-E copolymer different than the first P-E copolymer.

10. The composition of claim 1 further comprising at least one additive.

11. The composition of claim 10 in which the at least one additive is one or more of an antioxidant, UV stabilizer, cling additive, light stabilizer, thermal stabilizes, mold release agent, tackifier, wax, processing aid, crosslinking agent, colorant or pigment.

12. The composition of claim 11 in which the at least one additive is present in an amount of less than 30 wt % based upon the weight of the composition.

13. An article comprising the composition of claim 1.

14. The article of claim 13 in the form of cable sheathing, roofing membrane, sound deadening sheet, shoe sole or pipe.

15. The composition of claim 1 in which the P-E copolymer comprises 5 or more weight percent.

16. The composition of claim 1 in which the P-E copolymer comprises 7 or more weight percent.

17. The composition of claim 16 comprising 90 or more weight percent of filler.

18. The composition of claim 16 in which the P-E copolymer has a molecular weight distribution of between 2 and 4.

19. The composition of claim 18 in which the P-E copolymer has a weight average molecular weight of 150,000 to 350,000.

20. The composition of claim 19 in which the P-E copolymer has a density of 0.850 to 0.890 g/cm³, a crystallinity less than 35 percent, and a melting point of less than 60° C.
